(19) United States
(12) Patent Application Publication
(10) Pub. No.: US 2008/0109354 A1
(43) Pub. Date: May 8, 2008

(54) Account management

(76) Inventor: Kenneth Baker, Aboyne (GB)

Correspondence Address: DAVID S. RESNICK, 100 SUMMER STREET, NIXON PEABODY LLP, BOSTON, MA, 02110-2131, US

(21) Appl. No.: 11/542,937

(22) Filed: Oct. 4, 2006

(51) Int. Cl. G06Q 40/00

(52) U.S. Cl. 705/42

(57) ABSTRACT

According to the present invention there is provided a method of managing access to at least one service account comprising storing identify verification details of at least one service account in a repository and releasing the identity verification details to a third party on production of proof of death of a service account holder. The invention also provides a method of managing access to at least one internet banking account comprising storing identify verification details of at least one internet banking account in a repository and releasing the identity verification details to a third party on production of proof of death of a service account holder.

### BACKGROUND OF THE INVENTION

1. Field of the Invention

The present invention relates to account management, in particular to the management of access to a financial account.

2. Description of Related Art

For hundreds of years, people have been saving money with banks and other financial institutions. In the following description, the term “bank” is taken to refer to any organisation or body corporate that offers financial services including but not limited to at least one of the safekeeping of money, lending of money at interest or currency exchanging services, while the term “bank account” shall be construed accordingly as a contract a person has with the bank for the use of the bank's services such as the deposit or withdrawal of funds. To obtain a bank account, a person typically has to provide proof of identity and/or address, and then they are issued with a unique account number for the identification of their account with the bank.

In recent times, many banks and other financial institutions have started to offer their services on-line, where a customer can access a secure website in order to view his account status and carry out certain financial transactions. These activities are commonly termed “internet banking” although of course remote facilities of this kind can be enabled via any suitable computer or communications network. In order to access his account, the user has to supply identity verification details which can for example be a previously stored password, answer to personal question, or other code as appropriate, including combinations of the above. Security methods for passwords and user identification in this context are well known per se and will not be discussed in detail herein. Suffice it to say the present invention is in no way limited to any particular method.

There are also many services that establish their own accounts for the transfer of funds in consideration for the provision of the services. An organisation offering a service which is to be paid for can provide facilities for people to create accounts to which they can deposit funds as appropriate to pay for the services. Such accounts are hereafter referred to as “service accounts”. It is common for service accounts to be linked to people's bank accounts. That is, a user would typically give the service provider details of their bank account so that when the user instructs funds to be transferred into the service account, they are taken from his bank account as appropriate.

When opening a service account, the user has to set up unique identity verification details so that access to the service account is secure. For the case of on-line service accounts, the identity verification details typically comprise a username and password.

One example of a service account is that used for an on-line betting service. A user can establish an account which he then uses to transfer funds into and out of his existing bank account in order to have a readily available cash reserve for betting. Similar accounts are seen in stock broking, lotteries, sweepstakes, gambling and so on.

As well as on websites, similar service accounts can be set up for off-line use, or for use with micro credit cards, or “store cards” which can be credited or debited.

A problem with some service accounts is that the transactions are not easy to track from the bank account records due to the temporary nature of the accounts. If the account holder dies, the next of kin are not able to access the information and the funds are lost. This is particularly a problem when next of kin are not aware of the existence of the accounts, or even given an awareness that a particular service account exists the next of kin may not know the requisite user identity verification details needed to access the accounts and so any funds sitting in the service accounts are either very difficult to access or are lost altogether.

Similarly, in the case of an internet bank account, if the account holder dies, it can be difficult for the next of kin or other authorised third party to gain access to the accounts, or even in an extreme case, the deceased could have had a number of internet bank accounts of which the next of kin were unaware. In that case, there is a risk that any funds lying in the accounts would be lost upon death of the account holder.

### SUMMARY OF THE INVENTION

According to the present invention there is provided a method of managing access to at least one service account comprising storing identify verification details of at least one service account in a repository and releasing the identity verification details to a third party on production of proof of death of a service account holder. The invention also provides a method of managing access to at least one internet banking account comprising storing identify verification details of at least one internet banking account in a repository and releasing the identity verification details to a third party on production of proof of death of a service account holder.

In either case, the third party can then use the identity verification details to access the service account, which may be associated with at least one bank account. The proof of death would then be the proof of death of the bank account holder, and may suitably comprise a death certificate. The identity verification details will typically comprise a user name and password for accessing the service account.

The third party is then free to transfer funds from the service account to the bank account, and then to close the service account or to transfer its ownership to themselves or a different party.

The repository can comprise an electronic database, which may be populated by an on-line user interface.

The service account can be of any suitable type, including but not limited to a gaming account; a betting account; a stock brokerage account; a lottery account; and a sweepstake account. Each of these accounts may be provided on-line or off-line. The use of store cards and other micro credit cards is also in the scope of the invention.

A registration fee can be required to be paid in order for the identity verification details to be maintained in the repository and a registration number can be issued for each user, said registration number being required for the entry of new information and the redemption of the identity verification details; and further a registration card can be issued bearing the registration number and contact details of the account holder and the card issuer. The registration fee can be required to be paid again if the card is lost.

It is also possible to require the identity verification details to be kept hidden from everyone unless they are released to a third party on production of proof of death of a service account holder.

As well as providing the aforementioned method, the invention provides in various other aspects a corresponding repository and a website providing a graphical user interface for populating the repository.

### BRIEF DESCRIPTION OF THE DRAWINGS

The present invention will now be described, by way of example only, with reference to the accompanying drawings in which:

FIG. 1 shows a welcome page of a website for implementing a first embodiment of the present invention.

FIG. 2 shows data input fields of a website for new customers according to the first embodiment; and

FIG. 3 shows data input fields of a website for existing customers according to the first embodiment.

### DETAILED DESCRIPTION OF THE INVENTION

As mentioned above, the concepts discussed herein can be extended to any service account. For the purposes of illustration we shall firstly consider the field of internet gaming.

It is a tendency within the major internet gaming or sweepstake websites to operate in a similar fashion so that clients trust the security of the websites and are at ease with depositing money in different website accounts for betting sports, lotteries and so on.

Typically, to open an internet gaming account (which is understood to be one example type of service account as discussed above) the client accesses the required website and is given a user name by the internet site owner. They can then choose their own password which allows them to enter their own service account site. To gamble via the gaming website, the service account owner has to deposit an amount of money into their service account which enables them to gamble up to the amount deposited. Each transaction is checked against the funds available within the account holder's service account and is only processed if there are funds available to cover the stake wagered and any other potential losses.

To deposit money into their account the client has to register the details of their bank account from which money will automatically be withdrawn when the owner of the account makes a deposit into their gambling account. When withdrawing money from the internet gambling account the money can only be transferred back into the account that is was deposited from.

When the owner of the account makes a deposit into the gaming account the transfer is typically instant and the money is then made available for gaming. However, in contrast, if the user withdraws money from their internet gaming or sweepstake account there is usually a delay in the money being transferred from the gaming site into the owner's bank account. In some cases this clearance takes up to two or three days, and for this reason gamblers tend to leave an amount of “stake money” in their service account, rather than clear the service account out after each session or visit to the site. This means that a large amount of money can be deposited with a number of different service accounts which could be lost if the account owner were to die suddenly.

Internet gambling sites are silent about how the next of kin could act to close the account of a deceased account holder. However, even if there was help available on the websites the next of kin would need to know in the first place that an account existed. Sometimes the details of the account or even the existence of the account itself will not be known to the next of kin. This tendency towards secrecy is particularly prevalent with gaming accounts.

The present invention offers a way to avoid the loss of funds in the event of an account holder's death, while maintaining the privacy of the account holder. It effectively acts as a kind of insurance policy for the next of kin so that they know that funds will not be lost if the loved one was to die.

The solution is provided in the form of a repository, such as an electronic database, in which service account holders store their account details including the identity verification details for each service account. The account holder registers with the repository and informs his next of kin (or any other chosen third party) about his registration details. Then, if the account holder dies, the next of kin can provide a proof of death to the organisation that provides the repository in order to obtain the details of the accounts so that the funds can be transferred to the deceased's bank account to form part of his estate. Alternatively, the ownership of the service accounts can be transferred to the next of kin.

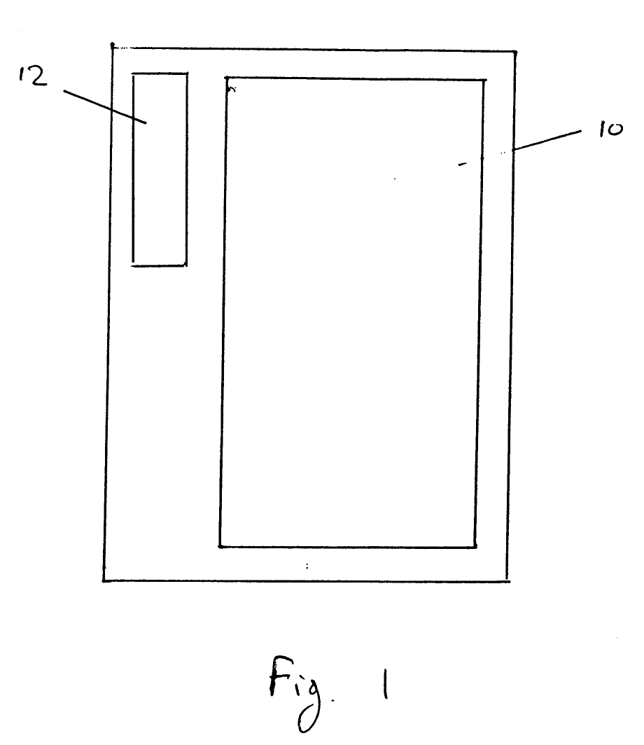

The repository is typically in the form of an electronic database, which is maintained by an organisation. FIG. 1 shows an example homepage of such an organisation's website which has an advertising section 10 comprising text and other data that explains the advantages of the site, and a menu portion 12 for navigation through the site.

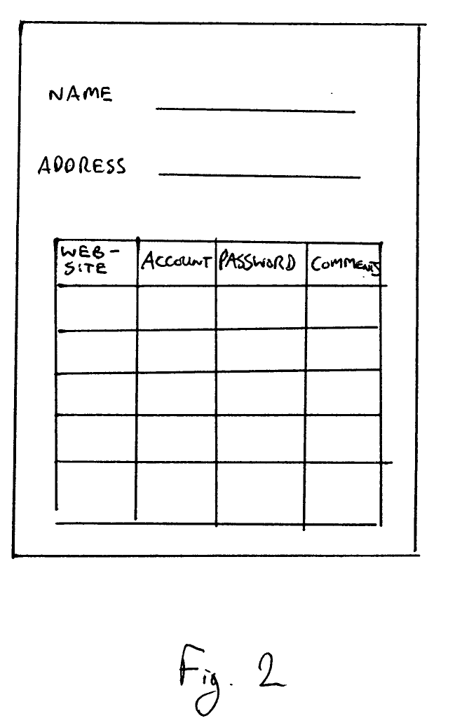

If a user wants to set up an account he navigates to a screen such as that shown in FIG. 2, which contains fields for him to input his name and address, and information about the service accounts, including for example the website URL/URI of the service, the type of account, the password, username and any other comments.

When the form is completed and payment of any applicable registration fee is confirmed the user is allocated a registration number and the information is transferred to a secure database and stored there under that unique registration number. Secure methods of storage are well know per se and will not be described in detail herein. In an optional embodiment the information stored under the client's registration number cannot be accessed by anybody, not even the client, unless a proof of death is produced.

The password bank administrators can then issue a registration card to the account holder which can for example be a credit card sized plastic card displaying the registration number and the contact details for the client and for the organisation.

It is to be appreciated that the present invention is not limited to any particular fee structure, but in one example the user would be required to pay a registration fee when creating an account, which would have to be paid again if he lost his registration details, while modifying the account details would be free of charge. Payment can be effected by any chosen on-line payment mechanism.

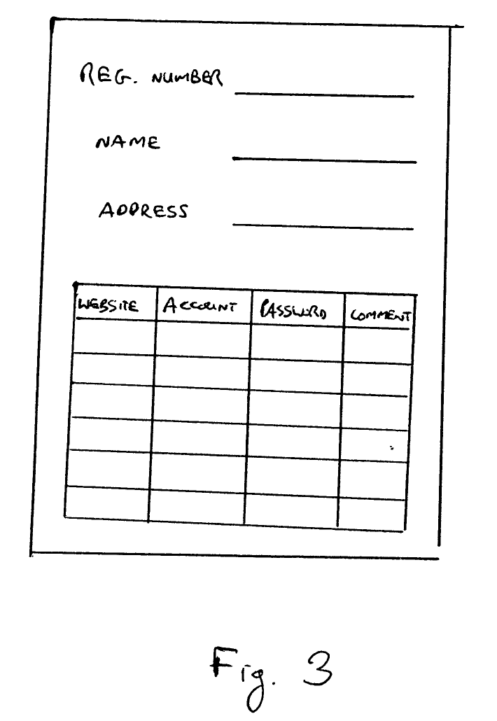

If the client's account details change, for example if they need to add another account or if they have closed down one of their accounts, they can access the account amendment webpage as shown on FIG. 3. They insert their registration number and fill out another form detailing the changes. Note that in one embodiment the client cannot view his existing details. This means that the service cannot just be used as a facility for retrieving forgotten passwords, but that is also gives the client peace of mind that nobody can access the information merely by obtaining his registration number.

If in the event of the account holder's death, the next of kin or other third party sends the registration card, along with a proof of death such as a death certificate to the organisation that maintains the database. The proof of death and the registration number are then verified and cross-checked before the service account details are released to the next of kin. The next of kin is then able to close down the deceased's accounts by visiting the gambling websites and can transfer funds from the accounts into the deceased's bank account. This would make any money held in the deceased's account visible to the executors of the wills and shouldn't form part of the deceased's will.

The next of kin may also have the option of keeping the service accounts going under another name.

As a further example, it will be appreciated that the idea can be extended to the field of internet banking, where the same risks of difficult access to funds or their complete loss upon death of the account holder apply. Details of an internet bank account can be stored in the same repository and dealt with in the same way as for the example of gaming accounts and other service accounts as discussed above.

It can be seen how these principals can be extended to other areas. Various improvements and modifications can be made to the above without departing from the spirit and scope of the present invention.

1. A method of managing access to at least one service account comprising storing identify verification details of at least one service account in a repository and releasing the identity verification details to a third party on production of proof of death of a service account holder.

2. The method of claim 1, wherein the third party uses the identity verification details to access the service account.

3. The method of claim 2, wherein the service account is associated with at least one bank account, and the proof of death is proof of death of the bank account holder.

4. The method of claim 3, wherein the third party transfers funds from the service account to the bank account.

5. The method of claim 2, wherein the third party closes the service account.

6. The method of claim 2, wherein the third party transfers the ownership of the service account to themselves or a different party.

7. The method of claim 1, wherein the repository comprises an electronic database.

8. The method of claim 7, wherein the electronic database is populated by an on-line user interface.

9. The method of claim 1, wherein the service account comprises an account selected from the group comprising: a gaming account; a betting account; a stock brokerage account; a lottery account; and a sweepstake account.

10. The method of claim 9, wherein the service account is provided on-line.

11. The method of claim 1, wherein the proof of death comprises a death certificate.

12. The method of claim 1, wherein the identity verification details comprises a user name and password for accessing the service account.

13. The method of claim 1, wherein a registration fee must be paid in order for the identity verification details to be maintained in the repository.

14. The method of claim 13, further comprising issuing a registration card bearing the registration number and contact details of the account holder and the card issuer.

15. The method of claim 14, wherein the registration fee needs to be paid again if the card is lost.

16. The method of claim 1, wherein a registration number is issued for each user, said registration number being required for the entry of new information and the redemption of the identity verification details.

17. The method of claim 1, wherein the identity verification details are kept hidden from everyone unless they are released to a third party on production of proof of death of a service account holder.

18. A repository for storing identity verification details of at least one service account, where the identity verification details can be released to a third party on production of a proof of death of a service account holder.

19. An on-line service comprising at least one webpage having a first user interface for the registration of a new user comprising data fields for collecting personal information and data fields for collecting information relating to at least one service account.

20. The on-line service of claim 19, further comprising a second user interface for existing users comprising data fields for collecting information relating to at least one new service account; and data fields for collecting information relating to amendments to be made to at least one new service account.

21. A method of managing access to at least one internet banking account comprising storing identify verification details of at least one internet banking account in a repository and releasing the identity verification details to a third party on production of proof of death of a service account holder.

22. The method of claim 21, wherein the third party uses the identity verification details to access the internet banking account.

23. The method of claim 22, wherein the proof of death is proof of death of the bank account holder.

24. The method of claim 22, wherein the third party closes the internet banking account.

25. The method of claim 22, wherein the third party transfers the ownership of the internet banking account to themselves or a different party.

26. The method of claim 21, wherein the repository comprises an electronic database.

27. The method of claim 26, wherein the electronic database is populated by an on-line user interface.

28. The method of claim 23, wherein the proof of death comprises a death certificate.

29. The method of claim 1, wherein the identity verification details comprises a password for accessing the internet banking account.

30. The method of claim 21, wherein a registration fee must be paid in order for the identity verification details to be maintained in the repository.

31. The method of claim 30, further comprising issuing a registration card bearing the registration number and contact details of the account holder and the card issuer.

32. The method of claim 31, wherein the registration fee needs to be paid again if the card is lost.

33. The method of claim 21, wherein a registration number is issued for each user, said registration number being required for the entry of new information and the redemption of the identity verification details.

34. The method of claim 21, wherein the identity verification details are kept hidden from everyone unless they are released to a third party on production of proof of death of a service account holder.

35. A repository for storing identity verification details of at least one internet banking account, where the identity verification details can be released to a third party on production of a proof of death of an internet banking account holder.

36. An on-line service comprising at least one webpage having a first user interface for the registration of a new user comprising data fields for collecting personal information and data fields for collecting information relating to at least one internet banking account.

37. The on-line service of claim 36, further comprising a second user interface for existing users comprising data fields for collecting information relating to at least one new internet banking account; and data fields for collecting information relating to amendments to be made to at least one new internet banking account.
